(19) United States
(12) Patent Application Publication
(10) Pub. No.: US 2014/0215090 A1
(43) Pub. Date: Jul. 31, 2014

(54) DFA SUB-SCANS

(71) Applicant: LSI CORPORATION, San Jose, CA (US)

(72) Inventors: Michael Ruehle, Albuquerque, NM (US); Adam Scislowicz, San Jose, CA (US); Nayan Amrutlal Suthar, Pune (IN); Umesh Ramkrishnarao Kasture, Pune (IN)

(73) Assignee: LSI CORPORATION, San Jose, CA (US)

(21) Appl. No.: 13/755,215

(22) Filed: Jan. 31, 2013

(51) Int. Cl. H04L 12/56

(52) U.S. Cl. CPC H04L 45/14
USPC 709/238

(57) ABSTRACT

In a DFA, a sub-scan is executed during a DFA scan. The sub-scan consumes input symbols out of sequence relative to the DFA scan, either forward or in reverse. An input symbol in the DFA scan is matched. A sub-scan command is supplied to the DFA. The sub-scan command is executed and at least one symbol is consumed in the sub-scan.

### BACKGROUND OF THE INVENTION

With the maturation of computer and networking technology, the volume and types of data transmitted on the various networks have grown considerably. For example, symbols in various formats may be used to represent data. These symbols may be in textual forms, such as ASCII, EBCDIC, 8-bit character sets or Unicode multi-byte characters, for example. Data may also be stored and transmitted in specialized binary formats representing executable code, sound, images, and video, for example. Along with the growth in the volume and types of data used in network communications, a need to process, understand, and transform the data has also increased. For example, the World Wide Web and the Internet comprise thousands of gateways, routers, switches, bridges and hubs that interconnect millions of computers. Information is exchanged using numerous high level on top of low level protocols. Further, instructions in other languages may be included with these standards, such as Java and Visual Basic. There are numerous instances when information may be interpreted to make routing decisions. It is common for protocols to be organized in a matter resulting in protocol specific headers and unrestricted payloads. Subdivision of the packet information into packets and providing each packet with a header is also common at the lowest level. This enables the routing information to be at a fixed location thus making it easy for routing hardware to find and interpret the information. With the increasing nature of the transmission of information, there is an increasing need to be able to identify the contents and nature of the information as it travels across servers and networks. Once information arrives at a server, having gone through all of the routing, processing and filtering along the way, it is typically further processed. This further processing necessarily needs to be high speed in nature. The first processing step that is typically required by protocols, filtering operations, and document type handlers is to organize sequences of symbols into meaningful, application specific classifications. Different applications use different terminology to describe this process. Text oriented applications typically call this type of processing lexical analysis. Other applications that handle non-text or mixed data types call the process pattern matching.

### SUMMARY OF THE INVENTION

An embodiment of the invention may therefore comprise a method of executing a sub-scan during a DFA scan, wherein the sub-scan consumes input symbols out of sequence relative to the DFA scan, the method comprising matching at least one input symbol in the DFA scan, supplying a sub-scan command to a DFA, processing the sub-scan command and consuming at least one input symbol in the sub-scan.

An embodiment of the invention may further comprise a method for matching rules in a DFA, the method comprising performing a primary DFA descent in a DFA engine, the descent comprising consuming input symbols from an input stream in sequence, matching the symbols and transitioning to a next state upon the matching, accessing a sub-scan command to commence a sub-scan, the sub-scan command being associated with a sub-DFA wherein input symbols from the input stream will be consumed out of sequence relative to the primary DFA descent, performing a sub-scan, wherein the results of the sub-scan will return a return value to the primary scan, the return value indicating whether the sub-scan matched a corresponding portion of one of the rules and continuing the primary DFA descent through a transition determined by the return value.

An embodiment of the invention may further comprise a system of matching rules in a DFA, the system comprising a DFA compiler enabled to generate a DFA from a ruleset, to encode the DFA into an instruction set, to identify sub-scan requirements, to separate automaton sub-expressions corresponding to the identified sub-scan requirements, to build sub-DFAs based on said automaton sub-expressions, to annotate a DFA portion with sub-scan commands linking to sub-DFA instructions and a DFA engine enabled to execute DFA descents using the DFA instructions, the execute enablement comprising the capability to save scan context in a storage system, jump to sub-scan states and symbol positions, execute a sub-scan descent, generate return values and resume a primary scan base on the return values.

### BRIEF DESCRIPTION OF THE DRAWINGS

FIG. 1 is an embodiment of a DFA with a sub-scan.

FIG. 2 is an embodiment of a DFA with a reverse sub-scan jump.

### DETAILED DESCRIPTION OF THE EMBODIMENTS

To find matches to regular expressions or similar pattern matching rules within a symbol stream, two main types of state machines may be constructed nondeterministic and deterministic finite automata (NFAs and DFAs). Abstractly, an NFA or DFA is a directed graph, in which each graph vertex is a state and each graph edge is labeled with a class of input symbols that it accepts in order to make a transition from a source state to a destination state on that symbol class. The defining difference between NFAs and DFAs is that any two out-transitions from a DFA state must have non-intersecting symbol classes, whereas a single NFA state may have multiple out-transitions labeled with classes containing the same symbol.

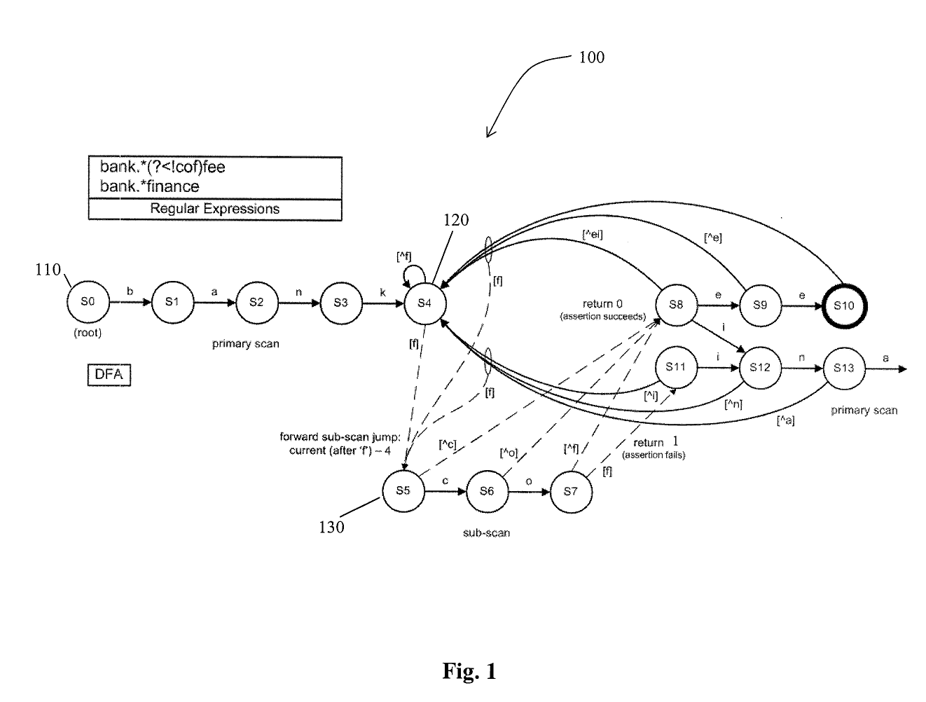

FIG. 1 illustrates a sample regular expression 110, a corresponding NFA 120 and DFA 130. In the embodiment of FIG. 1, the regular expression 110 defines search criteria that will match input data that begins with any number of characters from the character class [abcd], followed by a single character from the character class [abef], followed by a single character from the character class [aceg], followed by the character ‘h’. Thus, the regular expression comprises a spin expression, e.g., [abcd]*, where the ‘*’ indicates that any number of the preceding character class matches the constraint, that results in a DFA 130 with many more states than the corresponding NFA 120. In the embodiment of FIG. 1, the input streams comprising the characters “bach” and “bababbbbaaaaddddach”, for example, would each match the regular expression, while the characters “ebach” and “back”, for example, would not match the regular expression.

The exemplary NFA 120 comprises a state SO that either loops to itself upon receiving a character from the character class [abed] or transitions to a state S1 upon receiving a character from the character class [abef]. The multiple possible transitions from state S1 of the NFA 120 upon receiving characters ‘a’ or ‘b’ illustrate the non-determinism of the NFA 120. From state S1, the state machine transitions to state S2 upon receiving a character from the character class [abef], and becomes inactive in response to receiving any other characters. Finally, from state S2, the state machine transitions to state S3 upon receiving the character ‘h’, and becomes inactive in response to receiving any other character. In one embodiment, the state S3 may be associated with an output action, such as outputting a token indicating a match of the regular expression.

A single DFA is commonly constructed to find matches for many rules at once. A single execution of the DFA may be sufficient to find any match to any rule. Of course, it is also possible to construct and execute multiple DFAs for multiple rules, but the ability to find all matches using a single DFA is an over NFAs.

A traditional DFA is built to find matches to rules which start at only a single point in the input stream. The DFA has a root state, and a first symbol or character is consumed to make a transition from the root state to some next state. Further symbols are consumed to transition deeper until a match is found or the absence of a valid transition indicates there is no match. After finding matches, if any, starting at the first symbol by the DFA descent, additional DFA descents from the root state are need to find matches starting at later points in the input stream. In order to find all matches in the input stream, regardless of overlap, a separate DFA descent is needed beginning with each symbol of the stream. After a descent, whether it matches or not, the next DFA descent begins from the symbol immediately after the one used for beginning the previous descent. The amount of work needed to find all matches in an input stream is proportional to the length of the input stream, times the average number of steps in a DFA descent. When the average length of a DFA descent is high, a hardware or software DFA engine will operate with reduced performance.

Each DFA descent terminates after enough symbols are consumed to determine that all rules have failed to match, which his indicated by reaching a DFA state in which none of the out-transitions have symbol classes matching the next input symbol. When some rule matches a symbol string in the input stream, the corresponding DFA descent must be at least as long as the matching string. But at places in the input stream where there is no actual rule match, the averge DFA descent is less certain. If all rules have beginnings which are “strong” (difficult to match with arbitrary or random input), such as literal sequences of different symbols, such as “quickbrownfox”, the arbitrary input will typically fail matching for all rules quickly, such as after 1 to 3 symbols are consumed, in general. But if one or more rules have “weak” beginnings (easy to match with arbitrary or random input), such as sequences of wide symbol classes like “[A-Za-a]a-z][a-z][a-z0-9]”, then arbitrary input may easily match such rule beginnings for several symbols and therefore average DFA descent length may be high. As a result of the “strong”/“weak” dichotomy, a few rules with easily matched beginnings can substantially increase the work to find matches with a corresponding DFA. For example, 10,000 rules beginning with various multi-letter words from a dictionary may have an average DFA descent length of only 2.5 symbols with arbitrary input, but adding a single rule such as “[A-Za-z0-9] {3,8}_motor” might increase the average length to 7.5 symbols. Further, even if no rule has such a very easily matched beginning, the presence of a number of rules with moderately matched beginnings, such as beginnings containing single wide symbol classes, such as [0-9]123″ or “a[a-f]bcd” can still cumulatively result in significantly increased average DFA descent length.

Some extended regular expression languages support “look-around assertions”. These are sub-expressions appearing somewhere in a rule which do not consume any symbols but are defined to require that the symbols before or after the present position must match a certain pattern. Or, the symbols must not match a certain pattern in the case of a negative assertion. If the look-around is not satisfied, matching will not proceed. Commonly there are positive look-aheads, negative look-aheads, positive look-behinds and negative look-behinds available. Look-around assertions were introduced in an environment of software recursive NFA execution.

Although a single DFA is traditionally generated to match all rules of interest there are circumstances when it is impractical to combine all rules into one DFA. For example, certain types of complexities in multiple rules can interact to cause “state explosion”, in which a number of generated DFA states increases massively out of proportion to the number and length of rules. It is known that state explosion can be prevented by segregating interacting rules into different DFAs. Also, extended DFA features may utilize limited resources to provide advanced capabilities, such as saving “trail head” information to match rules with trailing context, saving pointers where sub-matches begin and end, saving partial matches for later rule back-references, or incrementing and testing counters to match quantifiers in rules with less states or state explosion. Too many rules may sometimes utilize these resources if they are all compiled into a single DFA. On the other hand, executing two or more DFAs is obviously more work, and can in its own terms reduce performance.

A DFA descent or scan is ordinarily executed as a single traversal of connected DFA states tracking a single current sate at a time, while sequentially consuming symbols of an input stream where each state-to-state transition in the DFA graph is taken if the consumed symbol matches the symbol class associated with that transition. An embodiment comprises a method to execute a DFA sub-scan within a primary DFA scan, where the sub-scan consumes symbols out of the ordinary sequence of the primary scan and may, or may not, return control to the primary scan when it completes. A DFA sub-scan may be used to alter the order of matching within a rule, such as matching the end of a rule first, followed by the beginning, such as for the purpose of reducing average DFA descent depth. It may also be used to verify a zero width assertion such as look-ahead, look-behind, or a byte-jump operator. It may also be used to bifurcate DFA execution into multiple sub-graphs to locally gain advantages of multiple DFAs such as reduced state explosion or fewer rules sharing limited resources without needing to execute multiple DFA descents from root states. It is understood that these are just examples of the uses of sub-scans and that other uses may be devised.

To implement DFA sub-scan capability, a primary DFA may have sub-scan commands annotated onto one or more states. A sub-scan command can comprise some or all of the following information:
A reference to the root state of a sub-DFA for the sub-scan;
A jump distance, which may be zero, or a positive or negative integer, indicating the relative position of the first symbol within the input stream to be consumed in the sub-scan;
A location code, indicating what location the jump distance should be relative to, such as the current symbol position, or the first symbol consumed by the primary scan, or the beginning of the symbol steam or packet;
A flag indicating the direction of the sub-scan, forward or backward;
A flag or code indicating whether the sub-scan should always return to the return conditionally, such as if the sub-scan finds a match; and
A flag or code indicating whether a return value is expected from the sub-scan, and if so, what type or format of return value (e.g. Boolean or N-bit integer), and how it should be used in the primary scan.

The sub-scan command may be encoded in DFA instructions, to be processed by a hardware or software DFA engine encountering the command upon reaching an annotated state during a DFA descent. To process the sub-scan command, the DFA engine should first save its current scan context, if the sub-scan is to return to the primary scan upon completion. Current scan context comprises current symbol and/or symbol position in the input stream, the current DFA state, instruction or instruction address. The scan context may be saved in registers or a memory. The scan context may be pushed onto a stack so that a further sub-scan may begin during the sub-scan, as in nested function calls, recursively or non-recursively and return to the primary scan through multiple levels of sub-scans by popping context from the stack.

After saving current scan context, the DFA engine should determine and access the first symbol position of the sub-scan using the indicated jump distance and location code and access the indicated root state of the sub-DFA, entering that state. Then, a first sub-scan DFA transition may be made by taking a transition from the sub-DFA root state corresponding to the first sub-scan symbol or by terminating if no transition matches that symbol. If a transition is taken into a next state of the sub-DFA, descent of the sub-DFA then continues, consuming successive adjacent symbols form the input stream.

The sub-scan command may indicate that the sub-scan is to run forward or backward. If forward, then the sub-DFA descent is done normally, consuming symbols in normal stream order. If backward, then symbols from the input stream are consumed in reverse, i.e. after the first sub-scan symbol position, that position minus one is accessed rather than that position plus one which is a normal forward progression. Backward scanning may be used for backward look-around (“look-behind”) assertions, e.g. where the look-behind sub-expression matches variable lengths. In the case of fixed-width look-behind, it is possible to jump the sub-scan to the first symbol position of the potential sub-expression match, by jumping to the position the known match length behind the primary scan position, and scan forward from there back to the primary scan position, where look-behind matching should complete. For example, in the expression “bank.*(?<!cof)fee”, the negative look-behind sub-expression “cof” has fixed 3-symbol width, so the sub-scan can jump to 3 symbols prior to the current scan position and match forward for ‘c’, ‘o’, ‘f’. In the case of variable-width look-behind, it is not known where a match may begin. Forward scanning can be used by jumping the maximum length back, if there is a finite maximum, but this may be inefficient because the actual match may start later. Using a backward sub-scan, the sub-scan can begin with the symbol at the end of potential look-behind matches, immediately before the present position, and scan back from there until the match completes at some start position of the look-behind match. For example, the expression “abc.*(?<=de*f)xyz” has variable width look-behind sub-expression “de*f”, so the sub-scan can jump to 1 symbol before the primary scan position and match backward for ‘f’ followed by any number of ‘e’ symbols, followed by ‘d’. For backward sub-scans, the sub-DFA must be constructed to match the sub-expression backward, e.g. the sub-DFA should be constructed to match “fe*d” in the example of “abc.*(?<=de*f)xyz”. In general, a reverse-matching DFA may be constructed in at least two different ways. First by reversing the sub-expression in obvious manners before compiling. Second by constructing an ordinary NFA and then reversing all NFA transitions and swapping the definitions of start states and accepting states. The DFA is then constructed from the reversed NFA by standard subset construction algorithms.

In the examples shown above, the look-behind sub-scan command may be annotated on the DFA state one step beyond the ‘.*’ state, after the next character is matched (‘f’ of ‘x’ respectively) even though this is not the explicit insertion point of the assertion. In this manner, the sub-scan will not execute from every iteration of the ‘.*’ state but only after matching the next character. To compensate for the late entry, the sub-scan jump distance should be one symbol further back. A sub-scan entry point may also be after all further symbols are matched (“fee” or “xyz” respectively) with jump distance 3 symbols further back. In which case, the primary scan may not need to continue.

Sub-scans with location code indicating the jump distance is relative to the current symbol position may similarly be used for positive or negative look-behind (scanning backwards from before the current position or jumping further back and scanning forward) or positive or negative look-ahead (scanning forward from the current position). These may also be used for SNORT byte-jump operators, jumping an indicated distance forward or backward and running the sub-scan forward, or for other similar assertions in a rule.

During sub-scan execution, the DFA engine may reach accepting states in the sub-DFA, which can be processed normally, as in reporting a match, such as in the form of a token comprising a rule ID, match start position (SP) and end position (EP). If the sub-scan is used to find a dependent but separate match, the SP and EP reported may be taken from the begin and end points of the sub-scan itself (swapped for reverse sub-scans). If the sub-scan is used to verify part of a match partially completed by the primary scan, the SP and EP reported may be taken from either the sub-scan or primary scan, such as using the lower start position as SP and the higher end position as EP. If the sub-scan is supposed to provide a return value to the primary scan, the indicated token ID in an accepting state may be used as a return value, or may determine a fixed return value such as 1, where if no match is found by the sub-scan, it may return another fixed value such as 0. Alternatively, the sub-scan may return a fixed value or token ID on a match, and terminate the primary scan if no match is found.

When the sub-scan terminates, if control is to be returned to the primary scan, the primary scan context is retrieved from where it was saved. This may be by reading from a register or memory, or popping off a context stack, and made again the current context of the DFA engine with additional information that the sub-scan already completed, and its return value, if any. If there is a return value, it is processed. The return value may be used to alter the trajectory of the remaining primary DFA descent, such as switching to a different DFA state before resuming. The return value may also influence the choice of transition from the current state. One way of doing this is if the next symbol to be consumed in the primary scan might lead to at most K transitions instructions for any return value V, then transition instruction K*V+J might be accessed, where J is determined by examining the next symbol.

Also, if there are N possible return values from 0 to N−1, then N intermediate states may be constructed in the primary DFA, each having transitions from the primary DFA state with the sub-scan command appropriate to the corresponding return value. A block of N instructions may additionally be constructed, each referencing a corresponding immediate state, and a base address of this instruction block may be encoded in the primary DFA instruction carrying the sub-scan command, and stored in scan context. The DFA engine can be configured so that when an accepting state is reached in the sub-scan with an instruction carrying a token ID, or when sub-scan match failure occurs, a next instruction is fetched from the instruction block at an index of 0 on match failure, or an index corresponding to the token ID of a match. When the primary scan resumes, this instruction is executed to enter or transition from the intermediate state corresponding to the return value.

FIG. 1 is an embodiment of a DFA with a sub-scan. The DFA 100 has a root state 110 that begins matching an input stream. As the DFA descent proceeds to state S4 120 a sub-scan will begin at S5 130. The S4 120 state will loop on any symbol from the input stream that is not “f”. The sub-scan here used as an example is a forward sub-scan, beginning with a 4 symbol negative jump. After “bank” is matched and the loop on “̂f”, the sub-scan will jump upon a match of “f” to ensure that “cof” does not precede the match. At each state, S5, S6, S7, of the sub-scan, two transitions are possible. On a match of the relevant symbol, “c”, “o”, “f”, respectively, the sub-scan will continue. However, if a match fails at any of those states. The transition will be to S8 which will continue transitioning. This transition to S8 represents a return from the sub-scan to the primary scan, with a return value of 0. In another embodiment, there will be a transition back to the state S4 120 originating the sub-scan first, followed by the transition to S8, but in the embodiment shown in FIG. 1, a step is saved by transitioning directly to S8. If “cof” is matched in the sub-scan, the transition will be to state S11 where the transitions will continue looking for the word “finance”. In this manner, it can be checked to see if the word being matched is “coffee” which is not relevant to the “bank” match or if the word being matched might be “finance”. Both “fee” and “finance” can be matched and “coffee” can be detected with the use of a sub-scan. Importantly, the sub-scan, S5, S6, S7, will return a return code to the primary scan. If the match of “cof” fails, then a return 0 results (assertion succeeds). If the match succeeds, then a return 1 results (assertion fails).

As noted above, in the regular expression “bank.*(?<!cof)fee” and “bank.*finance” of FIG. 1, a sub-scan is commanded from the state after matching “bank.*f” in each expression to jump back 4 symbols and match “cof”. Two intermediate states S8 and S11 may be constructed, where S8 is for the case where “cof” does not match (return value of 0), and S11 is for the case where “cof” does match (return value of 1). A block of 2 instructions is constructed with the instruction at block offset 0 referencing S8, and the instruction at block offset 1 referencing S11. Because the look-behind is a negative assertion, the expression “bank.*(?<!cof)fee” continues matching only from state S8, not from S11, whereas the other expression “bank.*finance” can continue matching from S8 or S11 because it has no such assertion. Thus, state S8 should taut two “progress” transitions on ‘e’ and ‘i’, whereas S11 should have only one progress transition on ‘i’. If “cof” matches in the sub-scan, the instruction from block offset 1 will be accessed and S11 will be entered as the primary scan resumes, and “bank.*(?<!cof)fe will not match further. But “bank.*finance” may continue matching. If “cof” does not match, then S8 will be entered and either expression may continue matching.

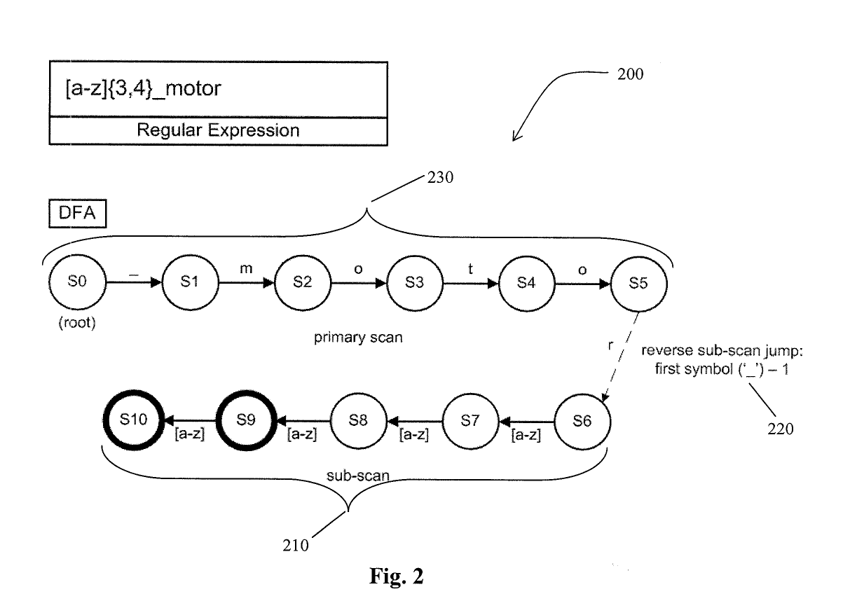

FIG. 2 is an embodiment of a DFA with a reverse sub-scan. In the DFA 200, a sub-scan 210 with a location code indicating the jump distance 220 is relative to the first symbol consumed by the primary scan 230 may be used to jump to the symbol before the start of the primary scan 230 and scan in reverse to extend the primary match backwards. This may be used for a rule with a weak beginning if some stronger section exists later in the rule, to avoid causing high average DFA descent length. For the example rule “[a-z] {3,4} motor”, the primary DFA could be constructed to match only the suffix “ motor”, which would generally not cause abnormally long average DFA descents. The accepting state after matching “ motor” would carry a sub-scan command 220 to jump to the position before the first symbol consumed by the primary scan and scan in reverse to match “[a-z] {3,4}”. It is noted that this sub-expression is the same forward and backward. If the sub-scan 210 matches, a match may be reported with SP from the last matching symbol of the sub-scan and EP from the end of the primary scan. Otherwise, no match is reported. In either case, the primary scan does not resume unless other rules matching “_motor” need to continue matching more symbols in the primary DFA. Every rule with a weak beginning followed by a stronger section may be handled in this manner of “delayed prefix matching”, in which the stronger end of each rule is matched first, followed by a reverse sub-scan starting from the position before the first symbol consumed by the DFA descent. The average DFA descent length for arbitrary input can be limited. Delayed prefix matching may also be done using forward sub-scans, for fixed length prefixes, or jumping the maximum prefix length before the first consumed symbol. Other alterations of normal forward rule matching order may be accomplished by sub-scans such as matching the beginning of a rule first, then jumping over a middle section and matching the end of the rule, then jumping back to match the middle of the rule.

If there is a place in the DFA where splitting rules into separate DFAs would minimize state explosion or resource overutilization, a single DFA may locally bifurcate into two, or more, branch DFAs by means of a sub-scan. To construct the bifurcation at a chosen DFA state, the involved rules should be divided into two groups and the chosen DFA state comprising a subset of NFA states from both rule groups should be divided into two, or more DFA states, each comprising the NFA states of that subset associated only with the rules in the associated rule group. DFA states reachable from the split states may then be generated by ordinary subset construction, and will naturally comprise only NFA states from the associated rule group. One of the two, or more, split states may be connected to parent states of the original chosen state, and annotated with a sub-scan command to initiate a forward sub-scan, should return to the primary scan on completion without a return value. During a DFA descent, when the bifurcation point is reached, first a sub-scan will descend one branch DFA, and then the resumed primary scan will descend the other branch DFA. If more than 2 DFA branches are used, multiple sub-scans will be undertaken from the bifurcation point, before resuming the primary for the final branch. Although such sub-scan operation on multiple DFA branches will gain the benefits of rules divided among multiple DFAs, all primary DFA descents will begin from a single root state, maintaining high performance except when the bifurcation point is reached, which may be minimally.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of executing a sub-scan during a DFA scan, wherein said sub-scan consumes input symbols out of sequence relative to said DFA scan, said method comprising:
matching at least one input symbol in said DFA scan;
supplying a sub-scan command to a DFA;
processing said sub-scan command; and
consuming at least one input symbol in said sub-scan.

2. The method of claim 1, wherein said step of supplying a sub-scan command comprises encoding at least one instruction with a sub-scan command.

3. The method of claim 2, wherein said sub-scan command comprises at least one of a reference to a root state of a sub-DFA for said sub-scan, a jump distance, a location code, a flag indicating the direction of said sub-scan, a flag indicating whether a return value is expected from said sub-scan, and a flag indicating whether said sub-scan should return to said DFA scan when said resulting sub-scan is complete.

4. The method of claim 1, wherein the process of processing said sub-scan command comprises accessing a second sub-scan command and performing said second sub-scan.

5. The method of claim 1, wherein the process of processing said sub-scan command comprises saving a current scan context and returning to said DFA scan after said sub-scan completes.

6. The method of claim 5, wherein saving a current scan context comprises saving a current scan context recursively to a stack.

7. The method of claim 1, wherein the process of processing said sub-scan command comprises:
saving a current scan context;
determining a first symbol position of said sub-scan;
accessing said first symbol position of said sub-scan;
accessing a root state of said sub-scan; and
entering said root state and taking a first sub-scan transition.

8. The method of claim 7, wherein taking a first sub-scan transition comprises matching a symbol in said sub-scan.

9. The method of claim 7, wherein taking a first sub-scan transition comprises taking an implied failure transition by terminating said sub-scan if no other transition matches.

10. The method of claim 1, wherein said sub-scan consumes input symbols in reverse order.

11. A method for matching rules in a DFA, said method comprising:
performing a primary DFA descent in a DFA engine, said descent comprising consuming input symbols from an input stream in sequence, matching said symbols and transitioning to a next state upon said matching;
accessing a sub-scan command to commence a sub-scan, said sub-scan command being associated with a sub-DFA wherein input symbols from said input stream will be consumed out of sequence relative to said primary DFA descent;
performing a sub-scan, wherein results of said sub-scan will return a return value to said primary descent, said return value indicating whether said sub-scan matched a corresponding portion of one of said rules; and
continuing said primary DFA descent through a transition determined by said return value.

12. The method of claim 11, wherein performing said sub-scan comprises accessing a second sub-scan command and performing a second sub-scan.

13. The method of claim 11 wherein said sub-scan is used to match a look-around assertion in one of said rules.

14. The method of claim 11, wherein said sub-scan is used to match a weak rule beginning.

15. The method of claim 11, wherein said sub-scan command comprises at least one of a reference to said root state of a sub-DFA for said sub-scan, a jump distance, a location code, a flag indicating the direction of said sub-scan, a flag indicating whether a return value is expected from said sub-scan, and a flag indicating whether said sub-scan should return to said DFA scan when it completes.

16. The method of claim 11, wherein said sub-scan command is encoded in a DFA instruction.

17. The method of claim 11, wherein said sub-scan consumes input symbols in reverse order.

18. The method of claim 11, wherein said step of performing said sub-scan comprises:
saving a current scan context;
determining a first symbol position of said sub-scan;
accessing first symbol position of said sub-scan;
accessing a root state of said sub-scan; and
entering said root state and taking a first sub-scan transition.

19. A system of matching rules in a DFA, said system comprising:
a DFA compiler enabled to generate a DFA from a ruleset, to encode said DFA into an instruction set, to identify sub-scan requirements, to separate automaton sub-expressions corresponding to said identified sub-scan requirements, to build sub-DFAs based on said automaton sub-expressions, to annotate a DFA portion with sub-scan commands linking to sub-DFA instructions; and
a DFA engine enabled to execute DFA descents using said DFA instructions, said execute enablement comprising a capability to save scan context in a storage system, jump to sub-scan states and symbol positions, execute a sub-scan descent, generate return values and resume a primary scan base on said return values.

20. The system of claim 19, wherein said sub-scan requirements comprise matching a look-around assertion.

21. The system of claim 19, wherein said sub-scan requirements comprise deferring matching of a weak rule beginning.

22. The system of claim 19, wherein said sub-scan requirements comprise splitting a portion of said DFA into a plurality of pieces.

23. The system of claim 19, wherein said sub-scan comprises a backward symbol consumption command.
